(19) United States
(12) Patent Application Publication
(10) Pub. No.: US 2026/0056644 A1
(43) Pub. Date: Feb. 26, 2026

(54) PAGE DISPLAY METHOD, APPARATUS, ELECTRONIC DEVICE AND STORAGE MEDIUM

(71) Applicant: DOUYIN VISION CO., LTD., Beijing (CN)

(72) Inventors: Xin Wang, Beijing (CN); Huijing Nie, Beijing (CN)

(21) Appl. No.: 19/226,537

(22) Filed: Jun. 3, 2025

(30) Foreign Application Priority Data
Aug. 26, 2024 (CN) 202411179194.6

(51) Int. Cl. G06F 3/0483

(52) U.S. Cl. CPC G06F 3/0483

(57) ABSTRACT

Embodiments of the present disclosure provide a page display method, an apparatus, an electronic device and a storage medium. The method includes displaying a latest content page of a first e-book in response to a first operation of a user on the first e-book. The method further includes displaying a first script entrance of a first script associated with the first e-book on the latest content page, or displaying a dialog entrance for a dialog with a digital assistant of the first e-book on the latest content page. The method further includes in a case that the first script entrance is displayed, in response to a trigger operation on the first script entrance, displaying a first script page of the first script. The method further includes in a case that the dialog entrance is displayed, in response to a trigger operation on the dialog entrance, displaying a dialog page.

### CROSS-REFERENCE TO RELATED APPLICATION(S)

This application claims priority to Chinese Application No. 202411179194.6 filed on Aug. 26, 2024, the disclosure of which is incorporated herein by reference in its entirety.

### FIELD

The present disclosure relates to the field of computer technologies, and in particular, to a page display method, an apparatus, an electronic device, and a storage medium.

### BACKGROUND

At present, users often read e-books, for example, install a reading application on a mobile phone and read e-books in the reading application. Considering that when a user reads an e-book, the reading cycle is long, and the reading efficiency may be reduced due to various factors, for example, the reading efficiency is reduced due to forgetting the content read before. Therefore, it is necessary to provide a technical solution to improve the reading efficiency of reading the e-book by the user.

### SUMMARY

Embodiments of the present disclosure provide a page display method, an apparatus, an electronic device, and a storage medium, which can display a first script page of a first script associated with a first e-book after a user finishes reading all updated contents of the e-book, or display a dialog page for a dialog with a digital assistant of the first e-book.

In a first aspect, an embodiment of the present disclosure provides a page display method, including: displaying a latest content page of a first e-book in response to a first operation of a user on the first e-book; displaying a first script entrance of a first script associated with the first e-book on the latest content page, or displaying a dialog entrance for a dialog with a digital assistant of the first e-book on the latest content page; in a case that the first script entrance is displayed, in response to a trigger operation of the user on the first script entrance, displaying a first script page of the first script, and the first script page being used to perform a first script task of the first script; and in a case that the dialog entrance is displayed, in response to a trigger operation of the user on the dialog entrance, displaying a dialog page, and the dialog page being used to the dialog with the digital assistant.

In a second aspect, an embodiment of the present disclosure provides a page display apparatus, including: a first display unit configured to display a latest content page of a first e-book in response to a first operation of a user on the first e-book; a second display unit configured to display a first script entrance of a first script associated with the first e-book on the latest content page, or display a dialog entrance for a dialog with a digital assistant of the first e-book on the latest content page; a first jump unit configured to, in a case that the first script entrance is displayed, in response to a trigger operation of the user on the first script entrance, display a first script page of the first script, and the first script page being used to perform a first script task of the first script; and a second jump unit, configured to, in a case that the dialog entrance is displayed, in response to a trigger operation of the user on the dialog entrance, display a dialog page, and the dialog page being used to the dialog with the digital assistant.

In a third aspect, an embodiment of the present disclosure provides an electronic device, including: a processor; and a memory configured to store computer-executable instructions which, when being executed, cause the processor to implement the steps of the method according to the above first aspect.

In a fourth aspect, an embodiment of the present disclosure provides a computer-readable storage medium, and the computer-readable storage medium is configured to store computer-executable instructions which, when being executed by a processor, implement the steps of the method according to the above first aspect.

In a fifth aspect, an embodiment of the present disclosure provides a computer program product, and the computer program product includes a computer program which, when being executed by a processor, implements the steps of the method according to the above first aspect.

### BRIEF DESCRIPTION OF THE DRAWINGS

In order to clearly describe the technical solutions in one or more embodiments of the present disclosure or in the prior art, the drawings required in the description of the embodiments or the prior art will be briefly introduced below. Obviously, the drawings in the following description are only some embodiments recorded in the present disclosure, and those skilled in the art can obtain other drawings according to these drawings without creative efforts.

FIG. 1 is a schematic flowchart of a page display method provided by an embodiment of the present disclosure;

FIG. 2a is a schematic diagram of a latest content page provided by an embodiment of the present disclosure;

FIG. 2b is a schematic diagram of a latest content page provided by another embodiment of the present disclosure;

FIG. 3a is a schematic diagram of a first script page provided by an embodiment of the present disclosure;

FIG. 3b is a schematic diagram of a dialog page provided by an embodiment of the present disclosure;

FIG. 4 is a schematic flowchart of a page display method provided by another embodiment of the present disclosure;

FIG. 5a is a schematic diagram of a content discussion page of a first e-book provided by an embodiment of the present disclosure;

FIG. 5b is a schematic diagram of a second script page provided by an embodiment of the present disclosure;

FIG. 5c is a schematic diagram of a target sub discussion page provided by an embodiment of the present disclosure;

FIG. 6 is a schematic flowchart of a page display method provided by yet another embodiment of the present disclosure;

FIG. 7a is a schematic diagram of a reading page of a first e-book provided by an embodiment of the present disclosure;

FIG. 7b is a schematic diagram of a dialog page for a dialog with a first character provided by an embodiment of the present disclosure;

FIG. 7c is a schematic diagram of a script list page of a first character provided by an embodiment of the present disclosure;

FIG. 7d is a schematic diagram of a third script page provided by an embodiment of the present disclosure;

FIG. 8 is a schematic structural diagram of a page display apparatus provided by an embodiment of the present disclosure; and

FIG. 9 is a schematic structural diagram of an electronic device provided by an embodiment of the present disclosure.

### DETAILED DESCRIPTION OF EMBODIMENTS

In order to enable those skilled in the art to better understand the technical solutions in one or more embodiments of the present disclosure, the technical solutions in the embodiments of the present disclosure will be clearly and completely described below with reference to the drawings in one or more embodiments of the present disclosure. Obviously, the described embodiments are only a part of the embodiments of the present disclosure, but not all of the embodiments. Based on the one or more embodiments of the present disclosure, all other embodiments obtained by those skilled in the art without creative efforts shall fall within the protection scope of the present disclosure.

It should be understood that, before using the technical solutions disclosed in the embodiments of the present disclosure, users should be informed of the type, range of use, usage scenario, etc. of the personal information involved in the present disclosure through appropriate means in accordance with relevant laws and regulations, and the authorization of the users should be obtained.

For example, in response to receiving an active request from a user, prompt information is sent to the user to explicitly prompt the user that the operation requested to be performed will require the acquisition and use of the user's personal information. Thus, the user can independently select whether to provide personal information to software or hardware, such as an electronic device, an application, a server, or a storage medium, that performs the operations of the technical solutions of the present disclosure based on the prompt information.

As an optional but non-restrictive implementation, the manner of sending the prompt information to the user in response to receiving the active request from the user may be, for example, in the form of a pop-up window, and the prompt information may be presented in the form of texts in the pop-up window. In addition, the pop-up window may also carry a selection control for the user to select “agree” or “disagree” to provide the personal information to the electronic device.

It should be understood that the above process of notifying and acquiring the user's authorization is merely illustrative, and does not constitute a limitation to the implementations of the present disclosure. Other manners that satisfy relevant laws and regulations may also be applied to the implementations of the present disclosure.

Embodiments of the present disclosure provide a page display method, which can display a first script page of a first script associated with a first e-book after a user finishes reading all updated contents of the e-book, or display a dialog page for a dialog with a digital assistant of the first e-book, thereby assisting the user to read the first e-book by means of providing the user with a first script task for performance, or by means of facilitating the user to perform the dialog with the digital assistant, and improving the reading efficiency of reading the first e-book by the user. The page display method in the embodiments of the present disclosure can be applied to a terminal device and performed by the terminal device, and the terminal device includes, but is not limited to, a mobile phone, a computer, a tablet computer, a notebook computer, a vehicle-mounted computer, a wearable device, a VR (Virtual Reality) device, and other electronic devices.

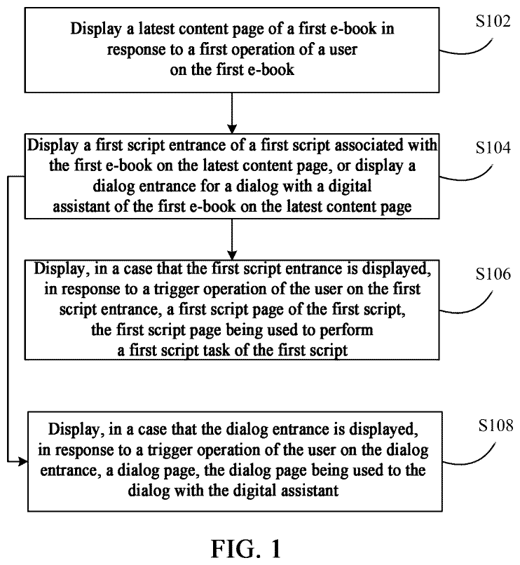

FIG. 1 is a schematic flowchart of a page display method provided by an embodiment of the present disclosure. As shown in FIG. 1, the process includes the following steps.

At step S102, a latest content page of a first e-book is displayed in response to a first operation of a user on the first e-book.

At step S104, a first script entrance of a first script associated with the first e-book is displayed on the latest content page, or a dialog entrance for a dialog with a digital assistant of the first e-book is displayed on the latest content page.

At step S106, in a case that the first script entrance is displayed, in response to a trigger operation of the user on the first script entrance, a first script page of the first script is displayed. The first script page is used to perform a first script task of the first script.

At step S108, in a case that the dialog entrance is displayed, in response to a trigger operation of the user on the dialog entrance, a dialog page is displayed. The dialog page is used to the dialog with the digital assistant.

In the embodiments of the present disclosure, firstly, the latest content page of the first e-book is displayed in response to the first operation of the user on the first e-book. Then, the first script entrance of the first script associated with the first e-book is displayed on the latest content page, or the dialog entrance for the dialog with the digital assistant of the first e-book is displayed on the latest content page. Finally, in a case that the first script entrance is displayed, in response to the trigger operation of the user on the first script entrance, the first script page of the first script is displayed, and the first script page is used to perform the first script task of the first script. In a case that the dialog entrance is displayed, in response to the trigger operation of the user on the dialog entrance, the dialog page is displayed, and the dialog page is used to the dialog with the digital assistant. It can be seen that, by the embodiment, the first script page of the first script associated with the first e-book can be displayed, or the dialog page for the dialog with the digital assistant of the first e-book can be displayed, after the user finishes reading all updated contents of the e-book, thereby assisting the user to read the first e-book by means of providing the user with the first script task for performance, or by means of facilitating the user to perform the dialog with the digital assistant, and improving the reading efficiency of reading the first e-book by the user.

In the above step S102, the latest content page of the first e-book is displayed in response to the first operation of the user on the first e-book. The first operation may be an operation of reading the first e-book, such as an operation of clicking on an icon of the first e-book to enter the first e-book, or an operation of turning pages of the first e-book. The first e-book may be any e-book, which is not limited here. In a case that the first e-book is a finished e-book, the latest content page of the first e-book may be the last page of the body text of the first e-book or the last page of the full text of the first e-book. In a case that the first e-book is a serialized e-book, the latest content page of the first e-book may be any page of the multi-page body text updated recently in the first e-book, for example, the latest content page of the first e-book is the last page of the multi-page body text updated recently in the first e-book. In an embodiment, in a case that the first e-book is a serialized e-book, the latest content page of the first e-book is a page displaying an entrance of reminder to update.

In the above step S104, the first script entrance of the first script associated with the first e-book is displayed on the latest content page, or the dialog entrance for the dialog with the digital assistant of the first e-book is displayed on the latest content page.

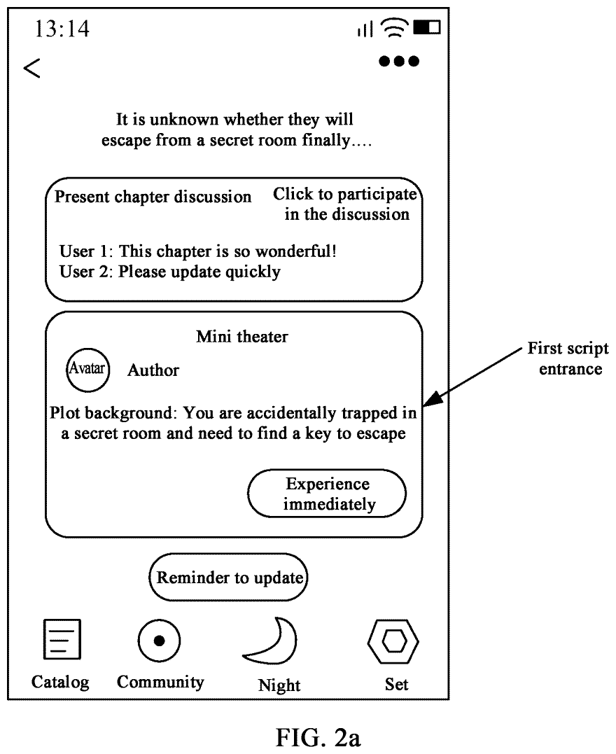

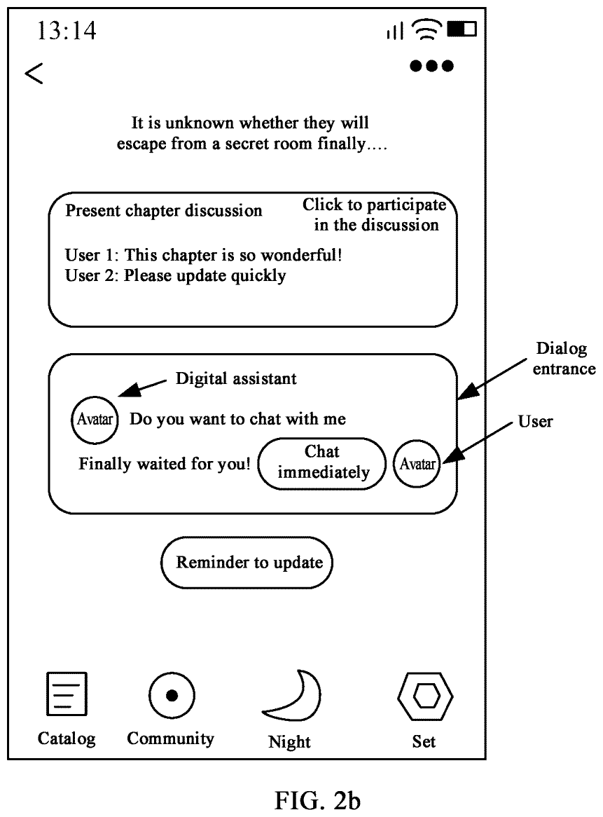

FIG. 2a is a schematic diagram of a latest content page provided by an embodiment of the present disclosure. As shown in FIG. 2a, taking the first e-book as a serialized e-book as an example, the latest content page is the last page of the multi-page body text updated recently in the first e-book, and the latest content page displays an entrance of reminder to update. In FIG. 2a, the first script entrance of the first script associated with the first e-book is displayed on the latest content page. In the embodiment, the first e-book is associated with a plurality of scripts, and the scripts may be created by an author of the first e-book, or by a book fan of the first e-book, or by an operation personnel of the first e-book. The script includes a plurality of chapters, each chapter including one or more tasks, and the user can perform the tasks of each chapter by means of having a dialog with a character in the script. The character in the script may be represented by a digital assistant, and the digital assistant may be a dialog robot generated based on a large language model. In the embodiment, a first script is determined from a plurality of scripts associated with the first e-book, and the first script entrance of the first script is displayed on the latest content page. As shown in FIG. 2a, the first script entrance may include a first script card, and the first script card displays copywriting content related to the first script and a first control. The copywriting content may refer to the part of “plot background” in FIG. 2a, and the first control may refer to the control of “experience immediately” in FIG. 2a. It can be jumped to the first script page of the first script by triggering the first control by the user.

FIG. 2b is a schematic diagram of a latest content page provided by another embodiment of the present disclosure. As shown in FIG. 2b, taking the first e-book as a serialized e-book as an example, the latest content page is the last page of the multi-page body text updated recently in the first e-book, and the latest content page displays an entrance reminder to update. In FIG. 2b, a dialog entrance for the dialog with the digital assistant of the first e-book is displayed on the latest content page. In the embodiment, the first e-book has the digital assistant, and the digital assistant may be a dialog robot generated based on a large language model, and the digital assistant may represent the first e-book or a certain character in the first e-book. As shown in FIG. 2b, the dialog entrance may include a dialog card, and the dialog card displays copywriting content for guiding the user to perform the dialog and a second control. The copywriting content may refer to the dialog part in FIG. 2b, and the second control may refer to the control of “chat immediately” in FIG. 2b. It can be jumped to the dialog page for the dialog with the digital assistant of the first e-book by triggering the second control by the user.

In the above step S106, in a case that the first script entrance is displayed, in response to the trigger operation of the user on the first script entrance, the first script page of the first script is displayed, and the first script page is used to perform the first script task of the first script. In the embodiment, in a case that the first script entrance is displayed, it can be jumped to the first script page of the first script by triggering the first script entrance by the user. Referring to FIG. 2a, in the case that the first script entrance includes a first script card, it can be jumped to the first script page of the first script by triggering a first control in the first script card by the user.

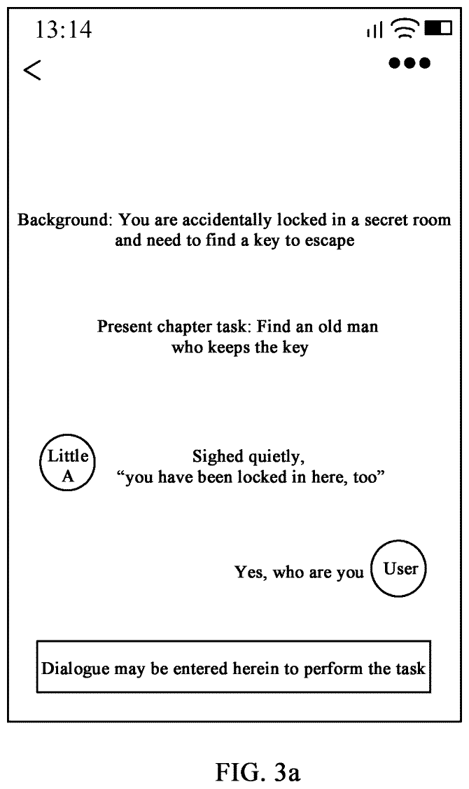

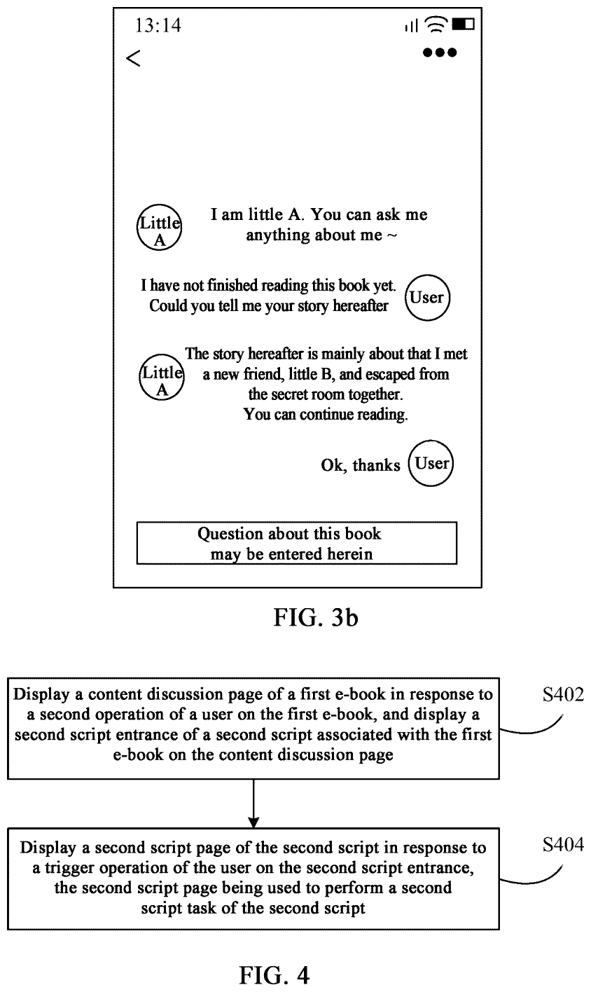

FIG. 3a is a schematic diagram of a first script page provided by an embodiment of the present disclosure. As shown in FIG. 3a, the first script page displays a digital assistant used to represent a certain character in the first script, and the character may also be a character of the first e-book. The user can perform the first script task of the first script by means of chatting with the digital assistant. The digital assistant may be a dialog robot generated based on a large language model, and the first script task includes tasks of a plurality of chapters.

In the above step S108, in a case that the dialog entrance is displayed, in response to the trigger operation of the user on the dialog entrance, the dialog page is displayed, and the dialog page is used to the dialog with the digital assistant of the first e-book. In the embodiment, in a case that the dialog entrance is displayed, it can be jumped to the dialog page for the dialog with the digital assistant of the first e-book by triggering the dialog entrance by the user. Referring to FIG. 2b, in a case that the dialog entrance includes a dialog card, it can be jumped to the dialog page for the dialog with the digital assistant of the first e-book by triggering the second control in the dialog card by the user.

FIG. 3b is a schematic diagram of a dialog page provided by an embodiment of the present disclosure. As shown in FIG. 3b, the dialog page displays a digital assistant used to represent the first e-book or a certain character in the first e-book, and the user can chat with the digital assistant to learn about the content of the first e-book or other content that needs to be learned. The digital assistant may be a dialog robot generated based on a large language model.

It can be seen that, by the embodiment, the first script page of the first script associated with the first e-book can be displayed, or the dialog page for the dialog with the digital assistant of the first e-book can be displayed, after the user finishes reading all updated contents of the e-book, thereby assisting the user to read the first e-book by means of providing the user with the first script task for performance, or by means of facilitating the user to perform the dialog with the digital assistant, and improving the reading efficiency of reading the first e-book by the user.

As described above, the first e-book is associated with a plurality of scripts, and the first script is determined from the plurality of scripts associated with the first e-book, so that the first script entrance of the first script is displayed on the latest content page. Based on this, in an embodiment, the first script entrance of the first script associated with the first e-book being displayed on the latest content page, or the dialog entrance for the dialog with the digital assistant of the first e-book being displayed on the latest content page includes: acquiring first operation data of the user on specified scripts, and determining, based on the first operation data, whether there is a script that needs to be displayed in the specified scripts, and the specified scripts including scripts associated with the first e-book; and in response to there being the script that needs to be displayed, taking the script that needs to be displayed as the first script, and displaying the first script entrance of the first script on the latest content page; or in response to there being no script that needs to be displayed, displaying the dialog entrance for the dialog with the digital assistant of the first e-book on the latest content page.

In the embodiment, the specified scripts include scripts associated with the first e-book, and there are a plurality of specified scripts. Firstly, first operation data of the user on each specified script is acquired, and the first operation data includes, but is not limited to, at least one of browsing data, task performance data, liking data, and forwarding data of the user on the specified script. Then, it is determined, based on the first operation data, whether there is the script that needs to be displayed in the specified scripts.

In response to there being the script that needs to be displayed, the script that needs to be displayed is taken as the first script, the first script entrance of the first script is generated, and the first script entrance of the first script is displayed on the latest content page; or in response to there being no script that needs to be displayed, the dialog entrance for the dialog with the digital assistant of the first e-book is displayed on the latest content page.

It can be seen that, by the embodiment, it is possible to determine, based on the first operation data of the user on each script associated with the first e-book, whether there is a first script that needs to be displayed in the scripts associated with the first e-book. In response to there being the first script that needs to be displayed, the first script entrance of the first script is displayed on the latest content page; or in response to there being no first script that needs to be displayed, the dialog entrance for the dialog with the digital assistant of the first e-book is displayed on the latest content page, so that the first script entrance is displayed or the dialog entrance is displayed in different cases, the user is assisted to read the first e-book in different cases, and the reading efficiency of reading the first e-book by the user is improved.

In an embodiment, whether there is the script that needs to be displayed in the specified scripts being determined based on the first operation data includes: in response to determining, based on the first operation data, that any one of the specified scripts has not been browsed by the user, determining that there is the script that needs to be displayed in the specified scripts, and taking a script with the most performance numbers in the specified script as the script that needs to be displayed; and in response to determining, based on the first operation data, that a first target script in the specified scripts has been browsed by the user, determining, based on a second operation data of the user on the first target script and a priority order among the specified scripts, whether there is the script that needs to be displayed in the specified scripts.

In the embodiment, whether any one of the specified scripts has been browsed by the user is determined based on the first operation data. In the embodiment, the user browsing the specified script refers to that the user enters a script page of the specified script. It can be understood that, in a case that the user performs the script task by means of performing a dialog with the digital assistant, the user may perform the script task or may not perform the script task after browsing the specified script, that is, the user browsing the specified script does not mean that the user necessarily performs the script task.

In response to determining that any one of the specified scripts has not been browsed by the user, it is determined that there is the script that needs to be displayed in the specified scripts, and the script with the most performance numbers in the specified scripts is taken as the script that needs to be displayed. The script with the most performance numbers is a script with the most players, and in a case that any one of the specified scripts has not been browsed by the user, recommending the script with the most players to the user can improve the experience of the user performing the script task.

In response to determining that the user has browsed the first target script in the specified scripts, second operation data of the user on the first target script is acquired, and the second operation data includes, but is not limited to, at least one of browsing data, task performance data, liking data, and forwarding data of the user on the first target script. Whether there is the script that needs to be displayed in the specified scripts is determined based on the second operation data of the user on the first target script and the priority order among the specified scripts.

In an embodiment, in response to a plurality of specified scripts having been browsed by the user, the script browsed by the user for the last time in the time sequence is determined as the first target script. It can be understood that the user may perform the script task or may not perform the script task after browsing the first target script.

It can be seen that, by the embodiment, in a case that any one of the specified scripts has not been browsed by the user, the script with the most players is recommended to the user, and the experience of the user performing the script task is improved. In a case that the first specified script has been browsed by the user, it is further accurately determined, based on the second operation data of the user on the first target script and the priority order among the specified scripts, whether there is the script that needs to be displayed in the specified scripts, and the accuracy of recommending the script to the user is improved.

In an embodiment, whether there is the script that needs to be displayed in the specified scripts being determined based on the second operation data of the user on the first target script and the priority order among the specified scripts includes: in response to the second operation data representing that a script task of the first target script has been performed by the user, and the script task of the first target script has not been completely performed, determining there being the script that needs to be displayed in the specified scripts, and taking the first target script as the script that needs to be displayed; and in response to the second operation data representing that the script task of the first target script has not been performed by the user, or in response to the second operation data representing that the script task of the first target script has been performed by the user and the script task of the first target script has been completely performed, determining, based on the priority order among the specified scripts, whether there is a script that needs to be displayed in the specified scripts.

In the embodiment, in one case, in response to determining, based on the task performance data in the second operation data, that the script task of the first target script has been performed by the user, and the script task of the first target script has not been completely performed, it is determined that there is the script that needs to be displayed in the specified scripts, and the first target script is taken as the script that needs to be displayed. In a case that the script task of the first target script has not been completely performed by the user, taking the first target script as the script that needs to be displayed can facilitate the user to continue to perform the script task of the first target script, and improve the experience of the user performing the script task.

In the embodiment, in another case, in response to determining, based on the task performance data in the second operation data, that the script task of the first target script has not been performed by the user, or in response to determining, based on the task performance data in the second operation data, that the script task of the first target script has been performed by the user, and the script task of the first target script has been completely performed, it represents that the user probably no longer wants to perform the script task of the first target script, and whether there is the script that needs to be displayed in the specified scripts is determined based on the priority order among the specified scripts.

It can be seen that, by the embodiment, in a case that the script task of the first target script has not been completely performed by the user, taking the first target script as the script that needs to be displayed can facilitate the user to continue to perform the script task of the first target script, and improve the experience of the user performing the script task. In addition, in a case that the first target script has been browsed by the user, but the script task of the first target script has not been performed, and in a case that all script tasks of the first target script have been completely performed by the user, whether there is the script that needs to be displayed in the specified scripts is determined based on the priority order among the specified scripts, so as to achieve the effect of accurately recommending the script to the user and improve the accuracy of script recommendation.

In an embodiment, whether there is a script that needs to be displayed in the specified scripts being determined based on the priority order among the specified scripts includes: in response to determining, based on the priority order among the specified scripts, there being a second target script with a priority ranking after the first target script in the specified scripts, determining there being the script that needs to be displayed in the specified scripts, and taking the second target script as the script that needs to be displayed; in response to determining, based on the priority order among the specified scripts, there being no second target script with a priority ranking after the first target script in the specified scripts, determining that there is no script that needs to be displayed in the specified scripts.

The priority order among the specified scripts is determined based on the authors of the specified scripts and the performance numbers of the specified scripts.

In the embodiment, the first e-book is associated with a plurality of specified scripts, and there is a priority order among the specified scripts. The priority order among the specified scripts is determined based on the authors of the specified scripts and the performance numbers of the specified scripts. In an example, the specified scripts are divided into two types. The authors of the first type of specified scripts are the authors of the first e-book or an operation personnel of the first e-book, and the authors of the second type of specified scripts are book fans of the first e-book. It can be set that the priority order of the first type of specified scripts is higher than the priority order of the second type of specified scripts. In each of the first type of specified scripts, the priority order of each of the first type of specified scripts from high to low is determined based on the order of the performance numbers of the scripts, that is, the numbers of players of the scripts, from high to low. In each of the second type of specified scripts, the priority order of each of the second type of specified scripts from high to low is determined based on the order of the performance numbers of the scripts, that is, the numbers of players of the scripts, from high to low, so as to generate the priority order among the specified scripts.

In the embodiment, after the priority order among the specified scripts is set, whether there is a second target script with a priority ranking after the first target script in the specified scripts is determined. The second target script may be a specified script ranked after the first target script and adjacent to the first target script in the order of priority from high to low. In response to there being a second target script, it is determined that there is the script that needs to be displayed in the specified scripts, and the second target script is taken as the script that needs to be displayed. On the contrary, in response to determining there being no second target script, that is, the first target script is the last specified script in the priority ranking, it is determined that there is no script that needs to be displayed in the specified scripts.

It can be seen that, by the embodiment, it is possible to determine, based on the priority order among the specified scripts, whether there is the script that needs to be displayed in the specified scripts, so as to recommend the specified scripts to the user based on the priority order among the specified scripts, and improve the experience of the user performing the script task.

As described above, in response to the first script being determined from the specified scripts, the first script entrance is acquired, and the first script entrance is displayed on the latest content page. Referring to FIG. 2a, it can be seen that the first script entrance may include a first script card, and the first script card displays copywriting content related to the first script and the first control. In addition, the first script card also displays the words “mini theater” as a title, and also displays an avatar and a user name.

In an example, in response to the first script being a script that has not been browsed by the user, the name and avatar of the author of the first script are displayed on the first script card, and the author of the first script may be the author of the first e-book, or an operation personnel of the first e-book, or a book fan of the first e-book. In response to the first script being a script that has been browsed or whose script task has been performed by the user, the name and avatar of a character in the first script are displayed on the first script card.

In an example, in response to the first script has not been browsed by the user or the first script has been browsed by the user but the first script task of the first script has not been performed, the first control may be a control of “experience immediately”. In response to the script task of a certain chapter of the first script has been performed by the user, the first control may be a control of “enter next chapter”. In response to the script task of a certain chapter of the first script having been performed by the user but the script task has not completely performed, the first control may be a control of “continue the present chapter”. It can be jumped to the first script page of the first script by triggering the first control by the user.

In an example, the copywriting content may refer to the part of “plot background” in FIG. 2a. In an embodiment, the first script entrance of the first script associated with the first e-book being displayed on the latest content page includes: acquiring at least one of author information of the first script, character information in the first script, content of the first script task, and third operation data of the user on the first script; determining copywriting content of the first script entrance based on the acquired information; and displaying the first script entrance on the latest content page based on the copywriting content of the first script entrance.

In the embodiment, firstly, at least one of author information of the first script, character information in the first script, content of the first script task, and third operation data of the user on the first script is acquired. The third operation data includes, but is not limited to, at least one of browsing data, task performance data, liking data, and forwarding data of the user on the first script.

Then, the copywriting content of the first script entrance is determined based on the acquired information. For example, in response to the first script task of the first script having not been performed by the user, the copywriting content may be a story background of the first script, and the story background may introduce related information of the author of the first script, related information of the character, or related information of the first script task. In response to the first script task of the first script having been performed by the user, the copywriting content may be task content matching the task performance progress of the user, such as an introduction to the task of a next chapter.

Finally, the first script entrance is generated based on the copywriting content of the first script entrance, and the first script entrance is displayed on the latest content page.

It can be seen that, by the embodiment, at least one of the author information of the first script, the character information in the first script, the content of the first script task, and the third operation data of the user on the first script can be acquired. The copywriting content of the first script entrance is determined based on the acquired information, and the first script entrance is displayed on the latest content page based on the copywriting content of the first script entrance, so that the copywriting content of the first script entrance is more accurate, and the experience of the user performing the first script task is improved.

After the first script entrance is displayed, the first script entrance can be triggered by the user to jump to the first script page, and the first script page is used to perform the first script task of the first script. In an embodiment, before the first script page of the first script is displayed, the method further includes: acquiring progress information of the first script task being performed by the user; and determining a script page of the first script matching the progress information as the first script page.

In the embodiment, after the first script entrance is displayed, in response to the trigger operation of the user on the first script entrance, the progress information of the first script task being performed by the user is acquired, the script page of the first script matching the progress information is determined as the first script page, and the first script page is displayed. For example, in response to the first script task has never been performed by the user, the home page of the first script may be determined as the first script page. In response to the script task of the second chapter of the first script having been performed by the user, the page of the second chapter of the first script is determined as the first script page.

It can be seen that, by the embodiment, the progress information of the first script task being performed by the user can also be acquired, and the script page of the first script matching the progress information is determined as the first script page, so that the user can browse the first script page that conforms to the performance progress of the first script task, which is convenient for the user to continue to perform the first script task.

As described above, in the embodiment, after the dialog entrance is displayed, it can be jumped to the dialog page for the dialog with the digital assistant of the first e-book by triggering the dialog entrance by the user. On the dialog page, the user can perform a dialog with the digital assistant of the first e-book to learn about the required information, and the required information may be related to the first e-book or may not be related to the first e-book.

FIG. 4 is a schematic flowchart of a page display method provided by another embodiment of the present disclosure. As shown in FIG. 4, the process includes the following steps.

At step S402, a content discussion page of the first e-book is displayed in response to a second operation of a user on the first e-book, and a second script entrance of a second script associated with the first e-book is displayed on the content discussion page.

At step S404, a second script page of the second script is displayed in response to a trigger operation of the user on the second script entrance. The second script page is used to perform a second script task of the second script.

The process of the method in FIG. 4 may occur after the process of the method in FIG. 1, or may occur before the process of the method in FIG. 1, which is not limited here.

In the above step S402, the second operation includes, but is not limited to, an operation of the user to enter the content discussion page of the first e-book. For example, the user triggers a “click to participate in the discussion” entrance on the latest content page of the first e-book, and the e-book reading application displays the content discussion page of the first e-book based on the trigger operation of the user. The content discussion page of the first e-book may also be referred to as a book circle page of the first e-book.

In the above step S402, the second script entrance of the second script associated with the first e-book is also displayed on the content discussion page of the first e-book. It can be understood that the second script is one of the above plurality of specified scripts. In an embodiment, a script for recommendation on the content discussion page may be determined from the plurality of specified scripts based on a recommendation strategy and taken as the second script. In yet another embodiment, a script whose script task has been performed by the user in the plurality of specified scripts may also be determined as the second script. Similar to the first script entrance, the second script entrance may also include a second script card.

In the above step S404, the second script page of the second script is displayed in response to the trigger operation of the user on the second script entrance, and the second script page is used to perform the second script task of the second script. In an embodiment, in response to the second script task of the second script having been performed by the user, the progress information of the second script task being performed by the user is acquired, and the script page of the second script matching the progress information is determined as the second script page, so as to facilitate the user to continue to perform the second script task of the second script.

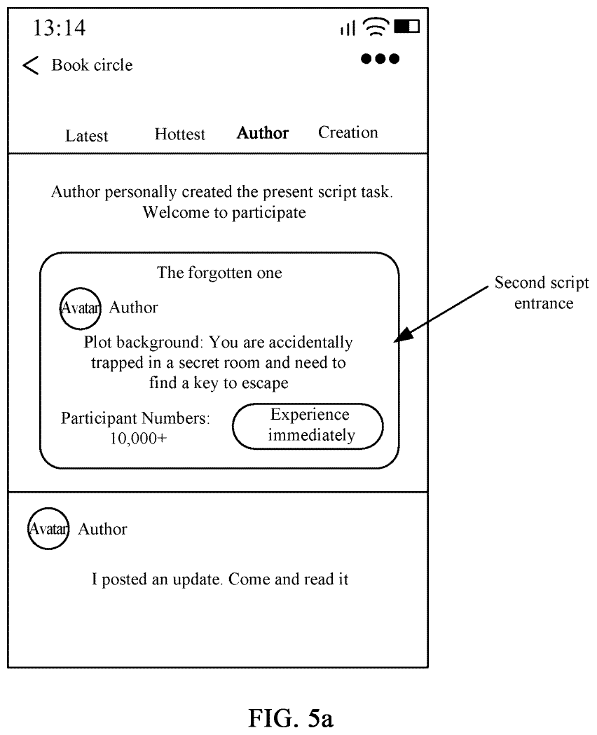

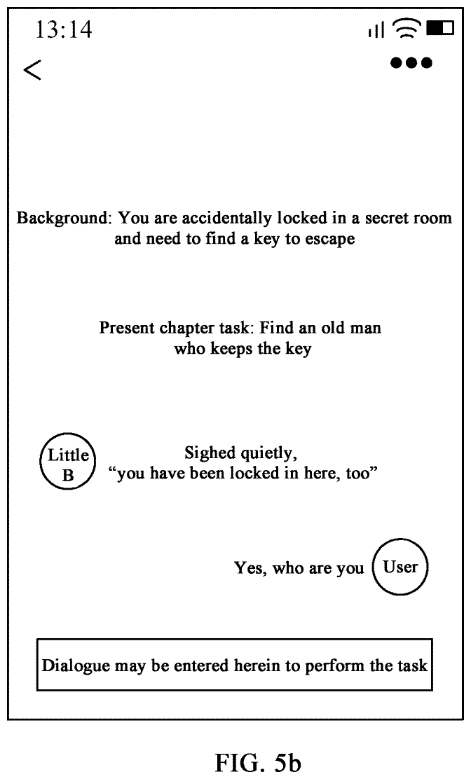

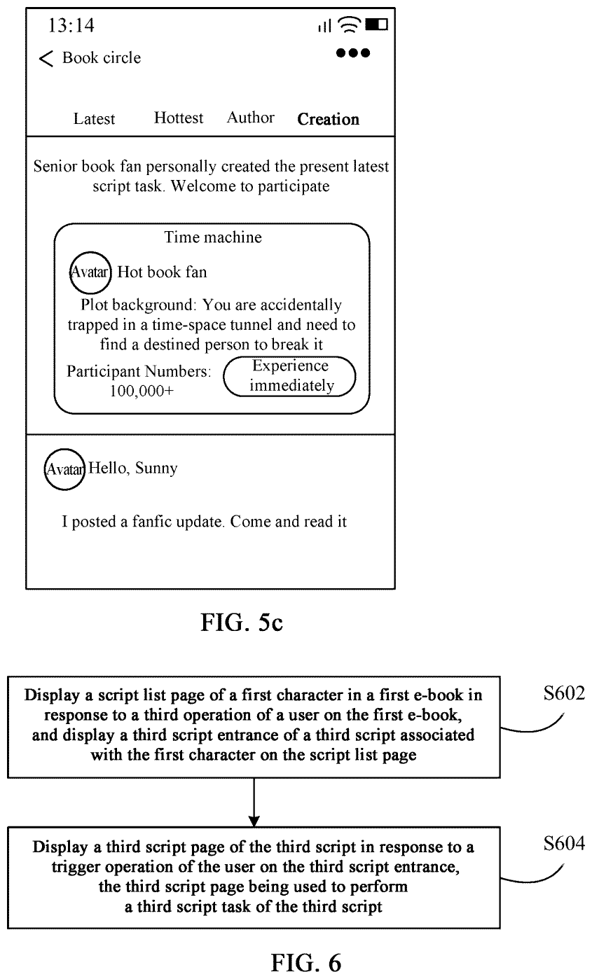

FIG. 5a is a schematic diagram of a content discussion page of a first e-book provided by an embodiment of the present disclosure. As shown in FIG. 5a, the content discussion page of the first e-book may be displayed, and the second script card of the second script is displayed on the content discussion page. The second script card includes components such as a plot background, a script title, the number of players, and a button of “experience immediately”, and the second script page can be entered by clicking the button or the second script card.

FIG. 5b is a schematic diagram of a second script page provided by an embodiment of the present disclosure. As shown in FIG. 5a and FIG. 5b, the user can click on the second script card or the button of “experience immediately” in the second script card to enter the second script page. The second script page displays a digital assistant used to represent a certain character in the second script, and the character may also be a character of the first e-book. The user can perform the second script task of the second script by means of chatting with the digital assistant. The digital assistant may be a dialog robot generated based on a large language model, and the second script task includes tasks of a plurality of chapters.

It can be seen that, by the embodiment, the second script of the first e-book can also be recommended to the user on the content discussion page of the first e-book, so that the script entrance is provided to the user in different scenarios, which is convenient for the user to perform the script task of the first e-book in different scenarios.

In an embodiment, before the second script entrance of the second script associated with the first e-book is displayed on the content discussion page, the method further includes: acquiring first operation data of a user on specified scripts, and the specified scripts including scripts associated with the first e-book; and determining the second script from the specified scripts based on the first operation data.

In the embodiment, the specified scripts include scripts associated with the first e-book, and there are a plurality of specified scripts. The author of the specified script may be the author of the first e-book, or an operation personnel of the first e-book, or a book fan of the first e-book. First operation data of the user on each specified script is acquired, and the first operation data includes, but is not limited to, at least one of browsing data, task performance data, liking data, and forwarding data of the user on the specified script.

Then, the second script is determined from the specified scripts based on the first operation data. For example, a specified script liked by the user is taken as the second script, or a specified script forwarded by the user is taken as the second script, or a specified script whose script task has been performed by the user before is determined as the second script, or a specified script browsed by the user is taken as the second script.

It can be seen that, by the embodiment, the second script can be determined from the specified scripts based on the first operation data of the user on each specified script, so as to improve the accuracy of recommending the second script to the user and improve the experience of the user performing the script task.

In an embodiment, the content discussion page includes a plurality of content discussion labels. The second script entrance of the second script associated with the first e-book being displayed on the content discussion page includes: in response to a trigger operation of the user on a target label in the plurality of content discussion labels, a target sub discussion page corresponding to the target label is displayed on the content discussion page; and displaying the second script entrance of the second script on the target sub discussion page. The second script is generated by a target author corresponding to the target label.

In the embodiment, the content discussion page includes a plurality of content discussion labels, such as the label of “author”, the label of “creation”, the label of “latest”, and the label of “hottest” as shown in FIG. 5a. The user can trigger any one of the plurality of content labels, and the triggered label is the target label. In response to the trigger operation of the user on the target label in the plurality of content discussion labels, the target sub discussion page corresponding to the target label is displayed on the content discussion page, and the target sub discussion page displays information provided by a target author corresponding to the target label. Taking FIG. 5a as an example, the user triggers the label of “author”, and the target sub discussion page corresponding to the label of “author” is displayed on the content discussion page. The target sub discussion page corresponding to the label of “author” displays information provided by the author of the first e-book or an operation personnel of the first e-book. FIG. 5c is a schematic diagram of a target sub discussion page provided by an embodiment of the present disclosure. As shown in FIG. 5c, the user triggers the label of “creation”, and the target sub discussion page corresponding to the label of “creation” is displayed on the content discussion page. The target sub discussion page corresponding to the label of “creation” displays information provided by a book fan of the first e-book.

Next, the second script entrance of the second script is displayed on the target sub discussion page, and the second script includes a script generated by the target author corresponding to the target label in the specified scripts. The specified scripts include scripts associated with the first e-book. That is, when the target sub discussion page is triggered and entered by the user, a script created by the target author corresponding to the target label is determined from the specified scripts and taken as the second script, and the second script entrance of the second script is displayed on the target sub discussion page.

It can be seen that, by the embodiment, the specified scripts can be divided based on the authors of the specified scripts. When the target label is triggered by the user, the specified script generated by the target author corresponding to the target label is determined as the second script, and the second script entrance of the second script is displayed on the target sub discussion page corresponding to the target label, so that it is convenient for the user to browse scripts created by different authors on different target sub discussion pages, and the convenience of the user browsing the scripts is improved.

FIG. 6 is a schematic flowchart of a page display method provided by yet another embodiment of the present disclosure. As shown in FIG. 6, the process includes the following steps.

At step S602, a script list page of a first character in a first e-book is displayed in response to a third operation of the user on the first e-book, and a third script entrance of a third script associated with the first character is displayed on the script list page.

At step S604, a third script page of the third script is displayed in response to a trigger operation of the user on the third script entrance. The third script page is used to perform a third script task of the third script.

The process of the method in FIG. 6 may occur after the process of the method in FIG. 1 or FIG. 4, or may occur before the process of the method in FIG. 1 or FIG. 4, or may occur during the process of the method in FIG. 1 or the process of the method in FIG. 4, which is not limited here.

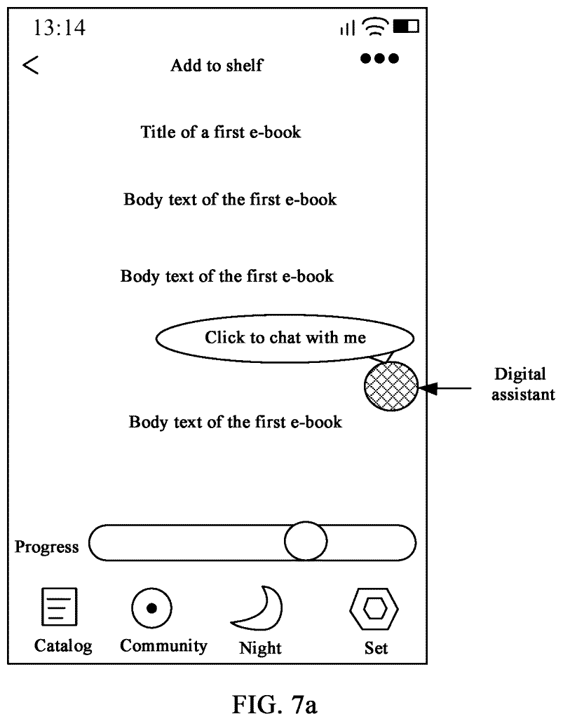

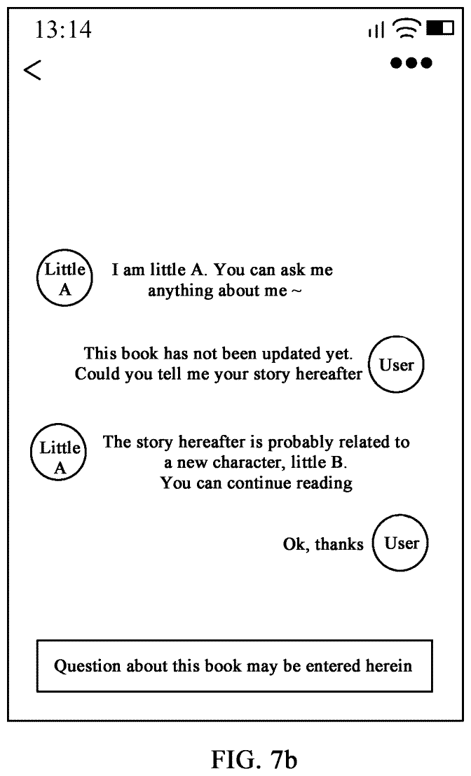

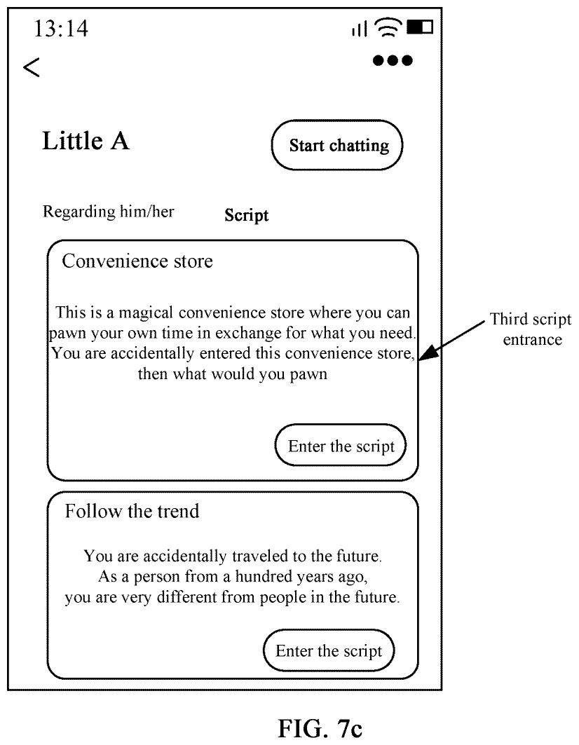

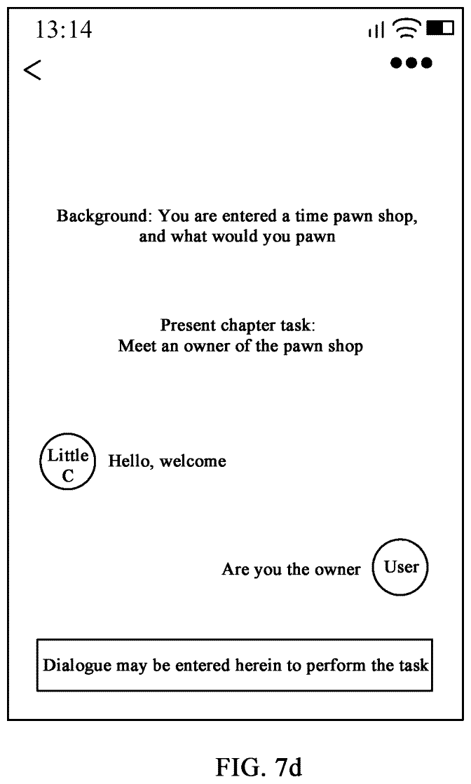

In the above step S602, the third operation includes, but is not limited to, an operation of entering the script list page of the first character. FIG. 7a is a schematic diagram of a reading page of a first e-book provided by an embodiment of the present disclosure. FIG. 7b is a schematic diagram of a dialog page for a dialog with a first character provided by an embodiment of the present disclosure. FIG. 7c is a schematic diagram of a script list page of a first character provided by an embodiment of the present disclosure. As shown in FIG. 7a, the user can click on an icon of a digital assistant on the reading page of the first e-book, and the digital assistant represents the first character in the first e-book. In response to the first click operation, the dialog page for the dialog with the first character as shown in FIG. 7b is displayed. Here, the first character is illustrated as little A. The user can click on the icon of the first character on the page, and in response to the second click operation, an introduction page of the first character is displayed. The user can click on a “script” control on the introduction page, and in response to the third click operation, the script list page of the first character as shown in FIG. 7c is displayed. Therefore, the third operation may include the above first click operation, second click operation, and third click operation.

As shown in FIG. 7c, the script list page displays the third script entrance of the third script associated with the first character. The third script is a script associated with the first character. Obviously, the third script is located in the above specified scripts, and the author of the third script may be the author of the first e-book, or an operation personnel of the first e-book, or a book fan of the first e-book. The third script entrance may also include a third script card, and the third script card displays information such as the number of players of the third script and introduction to the plot, and also displays a control to enter the script.

In the above step S604, the user can trigger the third script entrance, and the third script page of the third script is displayed in response to the trigger operation of the user on the third script entrance. The third script page is used to perform the third script task of the third script. FIG. 7d is a schematic diagram of a third script page provided by an embodiment of the present disclosure. As shown in FIG. 7d, the third script page displays a digital assistant used to represent the first character, and the user can perform the third script task of the third script by means of chatting with the digital assistant. The digital assistant may be a dialog robot generated based on a large language model, and the third script task includes tasks of a plurality of chapters.

It can be seen that, by the embodiment, the script list page of the first character in the first e-book can also be displayed, the third script entrance of the third script associated with the first character is displayed on the script list page. The third script page of the third script is displayed in response to the trigger operation of the user on the third script entrance, so as to facilitate the user to perform the third script task of the third script, so that the script entrance is provided to the user in different scenarios, which is convenient for the user to perform the script task of the first e-book in different scenarios.

In conclusion, by the above embodiments, the first script page of the first script associated with the first e-book can be displayed, or the dialog page for the dialog with the digital assistant of the first e-book can be displayed, after the user finishes reading all updated contents of the e-book, thereby assisting the user to read the first e-book by means of providing the user with the first script task for performance, or by means of facilitating the user to perform the dialog with the digital assistant, and improving the reading efficiency of reading the first e-book by the user.

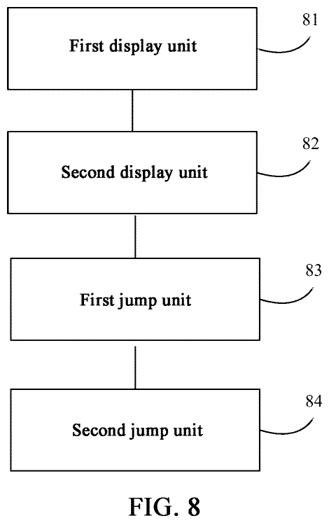

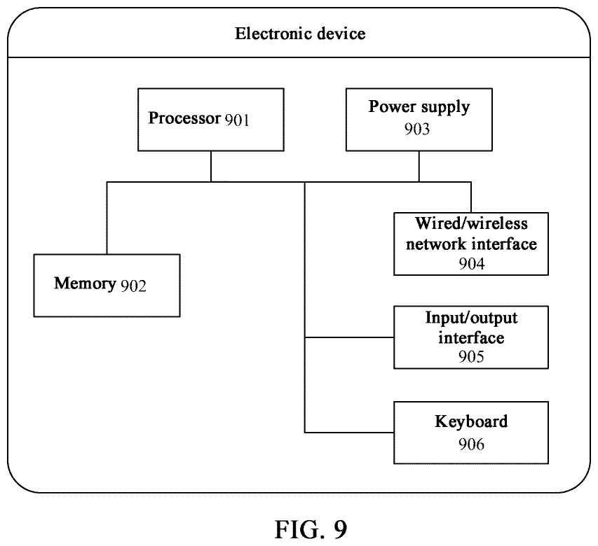

FIG. 8 is a schematic structural diagram of a page display apparatus according to an embodiment of the present disclosure. As shown in FIG. 8, the apparatus includes a first display unit 81, a second display unit 82, a first jump unit 83, and a second jump unit 84.

The first display unit 81 is configured to display a latest content page of a first e-book in response to a first operation of a user on the first e-book.

The second display unit 82 is configured to display a first script entrance of a first script associated with the first e-book on the latest content page, or display a dialog entrance for a dialog with a digital assistant of the first e-book on the latest content page.

The first jump unit 83 is configured to, in a case that the first script entrance is displayed, in response to a trigger operation of the user on the first script entrance, display a first script page of the first script. The first script page is used to perform a first script task of the first script.

The second jump unit 84 is configured to, in a case that the dialog entrance is displayed, in response to a trigger operation of the user on the dialog entrance, display a dialog page. The dialog page is used to the dialog with the digital assistant.

Optionally, the second display unit 82 is further configured to, acquire first operation data of the user on specified scripts, and determine, based on the first operation data, whether there is a script that needs to be displayed in the specified scripts, and the specified scripts including scripts associated with the first e-book; in response to there being the script that needs to be displayed, take the script that needs to be displayed as the first script, and display the first script entrance of the first script on the latest content page; or in response to there being no script that needs to be displayed, display the dialog entrance for the dialog with the digital assistant of the first e-book on the latest content page.

Optionally, the second display unit 82 is further configured to: in response to determining, based on the first operation data, that any one of the specified scripts has not been browsed by the user, determine there being a script that needs to be displayed in the specified scripts, and take a script with the most performance numbers in the specified scripts as the script that needs to be displayed; or in response to determining, based on the first operation data, that a first target script in the specified scripts has been browsed by the user, determine, based on second operation data of the user on the first target script and a priority order among the specified scripts, whether there is the script that needs to be displayed in the specified scripts.

Optionally, the second display unit 82 is further configured to, in response to the second operation data representing that the script task of the first target script has been performed by the user, and the script task of the first target script has not been completely performed, determine there being the script that needs to be displayed in the specified scripts, and take the first target script as the script that needs to be displayed; or in response to the second operation data representing that the script task of the first target script has not been performed by the user, or in response to the second operation data representing that the script task of the first target script has been performed by the user, and the script task of the first target script has been completely performed, determine, based on the priority order among the specified scripts, whether there is the script that needs to be displayed in the specified scripts.

Optionally, the second display unit 82 is particularly configured to, in response to determining, based on the priority order among the specified scripts, there being a second target script with a priority ranking after the first target script in the specified scripts, determine there being the script that needs to be displayed in the specified scripts, and take the second target script as the script that needs to be displayed; or in response to determining, based on the priority order among the specified scripts, there being no second target script with a priority ranking after the first target script in the specified scripts, determine there being no script that needs to be displayed in the specified scripts. The priority order among the specified scripts is determined based on the authors of the specified scripts and the performance numbers of the specified scripts.

Optionally, the second display unit 82 is particularly configured to: acquire at least one of author information of the first script, character information in the first script, content of the first script task, and third operation data of the user on the first script; determine copywriting content of the first script entrance based on the acquired information; and display the first script entrance on the latest content page based on the copywriting content of the first script entrance.

Optionally, the apparatus further includes a matching unit configured to, before the first script page of the first script is displayed, acquire progress information of the first script task being performed by the user, and determine a script page of the first script matching the progress information as the first script page.

Optionally, the apparatus further includes a third display unit and a third jump unit.

The third display unit is configured to display a content discussion page of the first e-book in response to a second operation of the user on the first e-book, and display a second script entrance of a second script associated with the first e-book on the content discussion page.

The third jump unit is configured to display a second script page of the second script in response to a trigger operation of the user on the second script entrance. The second script page is used to perform a second script task of the second script.

Optionally, the apparatus further includes a script determination unit configured to, before the second script entrance of the second script associated with the first e-book is displayed on the content discussion page, acquire first operation data of the user on specified scripts, and the specified scripts including scripts associated with the first e-book; and determine the second script from the specified scripts based on the first operation data.

Optionally, the content discussion page includes a plurality of content discussion labels; and the third display unit is particularly configured to, in response to a trigger operation of the user on a target label in the plurality of content discussion labels, display a target sub discussion page corresponding to the target label on the content discussion page; and display the second script entrance of the second script on the target sub discussion page. The second script is generated by a target author corresponding to the target label.

Optionally, the apparatus further includes a fourth display unit and a fourth jump unit.

The fourth display unit is configured to display a script list page of a first character in the first e-book in response to a third operation of the user on the first e-book, and display a third script entrance of a third script associated with the first character on the script list page.

The fourth jump unit is configured to display a third script page of the third script in response to a trigger operation of the user on the third script entrance. The third script page is used to perform a third script task of the third script.

The page display apparatus in the embodiment of the present disclosure can implement the various processes of the above page display method embodiments and achieve the same effects and functions, which will not be repeated here.

An embodiment of the present disclosure further provides an electronic device. FIG. 9 is a schematic structural diagram of an electronic device provided by an embodiment of the present disclosure. As shown in FIG. 9, the electronic device may have great differences due to different configurations or performances, and may include one or more processors 901 and a memory 902, and the memory 902 may store one or more applications or data. The memory 902 may be a transient storage or a persistent storage. The application stored in the memory 902 may include one or more modules (not shown in the figure), and each module may include a series of computer-executable instructions in the electronic device. Further, the processor 901 may be configured to communicate with the memory 902, and perform a series of computer-executable instructions in the memory 902 on the electronic device. The electronic device may further include one or more power supplies 903, one or more wired or wireless network interfaces 904, one or more input or output interfaces 905, one or more keyboards 906, and the like.

In a specific embodiment, the electronic device includes a processor and a memory configured to store computer-executable instructions, and the computer-executable instructions, when being executed, cause the processor to implement the following processes.

A latest content page of a first e-book is displayed in response to a first operation of a user on the first e-book.

A first script entrance of a first script associated with the first e-book is displayed on the latest content page, or a dialog entrance for a dialog with a digital assistant of the first e-book is displayed on the latest content page.

In a case that the first script entrance is displayed, in response to a trigger operation of the user on the first script entrance, a first script page of the first script is displayed. The first script page is used to perform a first script task of the first script.

In a case that the dialog entrance is displayed, in response to a trigger operation of the user on the dialog entrance, a dialog page is displayed. The dialog page is used to the dialog with the digital assistant.

The electronic device in the embodiment of the present disclosure can implement the various processes of the above page display method embodiments and achieve the same effects and functions, which will not be repeated here.

Another embodiment of the present disclosure further provides a computer-readable storage medium, the computer-readable storage medium is configured to store computer-executable instructions, and the computer-executable instructions, when being executed by a processor, implement the following processes.

A latest content page of a first e-book is displayed in response to a first operation of a user on the first e-book.

A first script entrance of a first script associated with the first e-book is displayed on the latest content page, or a dialog entrance for a dialog with a digital assistant of the first e-book is displayed on the latest content page.

In a case that the first script entrance is displayed, in response to a trigger operation of the user on the first script entrance, a first script page of the first script is displayed. The first script page is used to perform a first script task of the first script.

In a case that the dialog entrance is displayed, in response to a trigger operation of the user on the dialog entrance, a dialog page is displayed. The dialog page is used to the dialog with the digital assistant.

The storage medium in the embodiment of the present disclosure can implement the various processes of the above page display method embodiments and achieve the same effects and functions, which will not be repeated here.

Another embodiment of the present disclosure further provides a computer program product, the computer program product includes a computer program, and the computer program, when being executed by a processor, implements the following processes.

A latest content page of a first e-book is displayed in response to a first operation of a user on the first e-book.

A first script entrance of a first script associated with the first e-book is displayed on the latest content page, or a dialog entrance for a dialog with a digital assistant of the first e-book is displayed on the latest content page.

In the case that the first script entrance is displayed, in response to a trigger operation of the user on the first script entrance, a first script page of the first script is displayed. The first script page is used to perform a first script task of the first script.

In the case that the dialog entrance is displayed, in response to a trigger operation of the user on the dialog entrance, a dialog page is displayed. The dialog page is used to the dialog with the digital assistant.

The computer program product in the embodiment of the present disclosure can implement the various processes of the above page display method embodiments and achieve the same effects and functions, which will not be repeated here.

In various embodiments of the present disclosure, the computer-readable storage medium includes a read-only memory (abbreviated as ROM), a random-access memory (abbreviated as RAM), a magnetic disk, an optical disk, or the like.

In the 1990s, improvements to a technology can be clearly distinguished between hardware improvements (for example, improvements to circuit structures such as diodes, transistors, switches, etc.) and software improvements (improvements to method flows). However, with the development of technology, many improvements to method flows today can be regarded as direct improvements to hardware circuit structures. Designers almost always program the improved method flow into the hardware circuit to obtain the corresponding hardware circuit structure. Therefore, it cannot be said that an improvement to a method flow cannot be implemented by a hardware entity module. For example, a programmable logic device (PLD) (for example, a field programmable gate array (FPGA)) is such an integrated circuit, and its logic function is determined by programming the device by a user. A designer programs by himself or herself to “integrate” a digital system on a PLD, without asking a chip manufacturing factory to design and fabricate a dedicated integrated circuit chip. Moreover, today, instead of manually fabricating integrated circuit chips, such programming is mostly implemented by using “logic compiler” software, which is similar to the software compiler used in program development and writing, and the original code before compilation also needs to be written in a specific programming language, which is called hardware description language (HDL), and there are not only one HDL, but many kinds, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. At present, the most commonly used are VHDL (Very-High-Speed Integrated Circuit Hardware Description Language) and Verilog. Those skilled in the art should also be clear that it is only necessary to perform a little logical programming on the method flow with the above-mentioned hardware description languages and program it into the integrated circuit, and the hardware circuit that implements the logical method flow can be easily obtained.

The controller can be implemented in any suitable manner. For example, the controller can take the form of, for example, a microprocessor or a processor and a computer-readable medium storing computer-readable program codes (such as software or firmware) executable by the (micro) processor, a logic gate, a switch, an application specific integrated circuit (Application Specific Integrated Circuit, ASIC), a programmable logic controller, and an embedded microcontroller. Examples of the controller include, but are not limited to, the following microcontrollers: ARC 625D, Atmel AT91SAM, Microchip PIC18F26K20, and Silicone Labs C8051F320. The memory controller can also be implemented as part of the control logic of the memory. Those skilled in the art also know that in addition to implementing the controller in a pure computer-readable program code manner, it is also possible to program the method steps logically to enable the controller to implement the same functions in the form of a logic gate, a switch, an application specific integrated circuit, a programmable logic controller, an embedded microcontroller, and the like. Therefore, such a controller can be considered as a hardware component, and the apparatus included therein for implementing various functions can also be considered as a structure within the hardware component. Alternatively, it is even possible to consider the apparatus for implementing various functions as a software module that can implement the method or a structure within the hardware component.

The systems, apparatuses, modules, or units illustrated in the above embodiments may be implemented by a computer chip or entity, or may be implemented by a product with a certain function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For the convenience of description, the above apparatuses are described by dividing them into various units according to functions. Certainly, when implementing the embodiments of the present disclosure, the functions of the units may be implemented in the same one or more pieces of software and/or hardware.

Those skilled in the art should understand that one or more embodiments of the present disclosure may be provided as a method, a system, or a computer program product. Therefore, one or more embodiments of the present disclosure may take the form of an entirely hardware embodiment, an entirely software embodiment, or an embodiment combining software and hardware. Moreover, one or more embodiments of the present disclosure may take the form of a computer program product implemented on one or more computer-usable storage media (including but not limited to a magnetic disk memory, a CD-ROM, an optical memory, etc.) containing computer-usable program codes.

The present disclosure is described with reference to flowcharts and/or block diagrams of the method, the device (system), and the computer program product according to embodiments of the present disclosure. It should be understood that each flow and/or block in the flowcharts and/or block diagrams, and a combination of the flows and/or blocks in the flowcharts and/or block diagrams may be implemented by computer program instructions. These computer program instructions can be provided to a processor of a general-purpose computer, a dedicated computer, an embedded processor, or other programmable data processing device to produce a machine, so that the instructions executed by the processor of the computer or other programmable data processing device produce an apparatus for implementing the functions specified in one flow or a plurality of flows in the flowcharts and/or one block or a plurality of blocks in the block diagrams.

These computer program instructions can also be stored in a computer-readable memory that can guide the computer or other programmable data processing device to work in a specific manner, so that the instructions stored in the computer-readable memory produce an article of manufacture including the instruction apparatus, and the instruction apparatus implements the functions specified in one flow or a plurality of flows in the flowcharts and/or one block or a plurality of blocks in the block diagrams.

These computer program instructions can also be loaded onto the computer or other programmable data processing device, so that a series of operation steps are performed on the computer or other programmable device to produce a computer-implemented processing, so that the instructions executed on the computer or other programmable device provide steps for implementing the functions specified in one flow or a plurality of flows in the flowcharts and/or one block or a plurality of blocks in the block diagrams.

It should be further noted that the term “include/comprise” or any other variant thereof is intended to cover a non-exclusive inclusion, so that a process, method, article or device including a series of elements not only includes those elements but also includes other elements not expressly listed, or further includes elements inherent to such process, method, article or device. Without more restrictions, an element defined by a statement “include/comprise one . . . ” does not exclude the presence of other identical elements in the process, method, article or device including the element.

One or more embodiments of the present disclosure may be described in a general context of computer-executable instructions executed by a computer, for example, program modules. Generally, the program modules include routines, programs, objects, components, data structures, etc. for executing specific tasks or implementing specific abstract data types. One or more embodiments of the present disclosure may also be practiced in distributed computing environments, in which tasks are performed by remote processing devices connected through a communication network. In the distributed computing environment, the program modules may be located in local and remote computer storage media including a storage device.

Various embodiments in the present disclosure are described in a progressive manner, and identical or similar parts between various embodiments are referred to each other, and each embodiment focuses on differences from other embodiments. In particular, for the system embodiment, since it is basically similar to the method embodiment, the description is relatively simple, and reference may be made to the description of the method embodiment for relevant parts.

The above description is only embodiments of the present disclosure, but is not intended to limit the present disclosure. For those skilled in the art, the present disclosure may have various modifications and changes. Any modification, equivalent replacement, improvement, etc. made within the spirit and principle of the present disclosure shall be included in the scope of claims of the present disclosure.

I/We claim:

1. A page display method, comprising:
displaying a latest content page of a first e-book in response to a first operation of a user on the first e-book;
displaying a first script entrance of a first script associated with the first e-book on the latest content page, or displaying a dialog entrance for a dialog with a digital assistant of the first e-book on the latest content page;
displaying, in a case that the first script entrance is displayed, in response to a trigger operation of the user on the first script entrance, a first script page of the first script, the first script page being used to perform a first script task of the first script; and
displaying, in a case that the dialog entrance is displayed, in response to a trigger operation of the user on the dialog entrance, a dialog page, the dialog page being used to the dialog with the digital assistant.

2. The method according to claim 1, wherein displaying the first script entrance of the first script associated with the first e-book on the latest content page, or displaying the dialog entrance for the dialog with the digital assistant of the first e-book on the latest content page comprises:
acquiring first operation data of the user on specified scripts, and determining, based on the first operation data, whether there is a script that needs to be displayed in the specified scripts, the specified scripts comprising scripts associated with the first e-book; and
taking, in response to there being the script that needs to be displayed, the script that needs to be displayed as the first script, and displaying the first script entrance of the first script on the latest content page; or displaying, in response to there being no script that needs to be displayed, the dialog entrance for the dialog with the digital assistant of the first e-book on the latest content page.

3. The method according to claim 2, wherein determining, based on the first operation data, whether there is the script that needs to be displayed in the specified scripts comprises:
determining, in response to determining that any one of the specified scripts has not been browsed by the user based on the first operation data, there being the script that needs to be displayed in the specified scripts, and taking a script with most performance numbers in the specified scripts as the script that needs to be displayed; and
determining, in response to determining that a first target script in the specified scripts has been browsed by the user based on the first operation data, whether there is the script that needs to be displayed in the specified scripts based on second operation data of the user on the first target script and a priority order among the specified scripts.

4. The method according to claim 3, wherein determining whether there is the script that needs to be displayed in the specified scripts based on the second operation data of the user on the first target script and the priority order among the specified scripts comprises:
determining, in response to the second operation data representing that a script task of the first target script has been performed by the user and the script task of the first target script has not been completely performed, there being the script that needs to be displayed in the specified scripts, and taking the first target script as the script that needs to be displayed; and
determining, based on the priority order among the specified scripts, whether there is the script that needs to be displayed in the specified scripts, in response to the second operation data representing that the script task of the first target script has not been performed by the user, or in response to the second operation data representing that the script task of the first target script has been performed by the user, and the script task of the first target script has been completely performed.

5. The method according to claim 4, wherein determining, based on the priority order among the specified scripts, whether there is the script that needs to be displayed in the specified scripts comprises:
determining, in response to determining there being a second target script with a priority ranking after the first target script in the specified scripts based on the priority order among the specified scripts, there being the script that needs to be displayed in the specified scripts, and taking the second target script as the script that needs to be displayed; and
determining, in response to determining there being no second target script with the priority ranking after the first target script in the specified scripts based on the priority order among the specified scripts, there being no script that needs to be displayed in the specified scripts,
wherein the priority order among the specified scripts is determined based on authors of the specified scripts and performance numbers of the specified scripts.

6. The method according to claim 1, wherein displaying the first script entrance of the first script associated with the first e-book on the latest content page comprises:
acquiring at least one of follows: author information of the first script, character information in the first script, content of the first script task, and third operation data of the user on the first script;
determining copywriting content of the first script entrance based on the acquired information; and
displaying the first script entrance on the latest content page based on the copywriting content of the first script entrance.

7. The method according to claim 1, wherein before displaying the first script page of the first script, the method further comprises:
acquiring progress information of the first script task being performed by the user; and
determining a script page of the first script matching the progress information as the first script page.

8. The method according to claim 1, further comprising:
displaying a content discussion page of the first e-book in response to a second operation of the user on the first e-book, and displaying a second script entrance of a second script associated with the first e-book on the content discussion page; and
displaying a second script page of the second script in response to a trigger operation of the user on the second script entrance, the second script page being used to perform a second script task of the second script.

9. The method according to claim 8, wherein before displaying the second script entrance of the second script associated with the first e-book on the content discussion page, the method further comprises:
acquiring first operation data of the user on specified scripts, and the specified scripts comprising a script associated with the first e-book; and
determining the second script from the specified scripts based on the first operation data.

10. The method according to claim 8, wherein the content discussion page comprises a plurality of content discussion labels; and displaying the second script entrance of the second script associated with the first e-book on the content discussion page comprises:
displaying, in response to a trigger operation of the user on a target label in the plurality of content discussion labels, a target sub discussion page corresponding to the target label on the content discussion page; and
displaying the second script entrance of the second script on the target sub discussion page, the second script being generated by a target author corresponding to the target label.

11. The method according to claim 1, further comprising:
displaying a script list page of a first character in the first e-book in response to a third operation of the user on the first e-book, and displaying a third script entrance of a third script associated with the first character on the script list page; and
displaying a third script page of the third script in response to a trigger operation of the user on the third script entrance, the third script page being used to perform a third script task of the third script.

12. An electronic device, comprising:
a processor; and
a memory configured to store computer-executable instructions which, when being executed, configured the processor to:
display a latest content page of a first e-book in response to a first operation of a user on the first e-book;
display a first script entrance of a first script associated with the first e-book on the latest content page, or display a dialog entrance for a dialog with a digital assistant of the first e-book on the latest content page;
display, in a case that the first script entrance is displayed, in response to a trigger operation of the user on the first script entrance, a first script page of the first script, the first script page being used to perform a first script task of the first script; and
display, in a case that the dialog entrance is displayed, in response to a trigger operation of the user on the dialog entrance, a dialog page, the dialog page being used to the dialog with the digital assistant.

13. The electronic device according to claim 12, wherein the computer-executable instructions configured the processor to display the first script entrance of the first script associated with the first e-book on the latest content page, or display the dialog entrance for the dialog with the digital assistant of the first e-book on the latest content page comprise instructions to configure the processor to:
acquire first operation data of the user on specified scripts, and determine, based on the first operation data, whether there is a script that needs to be displayed in the specified scripts, the specified scripts comprising scripts associated with the first e-book; and
take, in response to there being the script that needs to be displayed, the script that needs to be displayed as the first script, and display the first script entrance of the first script on the latest content page; or display, in response to there being no script that needs to be displayed, the dialog entrance for the dialog with the digital assistant of the first e-book on the latest content page.

14. The electronic device according to claim 13, wherein the computer-executable instructions configured the processor to determine, based on the first operation data, whether there is the script that needs to be displayed in the specified scripts comprise instructions to configure the processor to:
determine, in response to determining that any one of the specified scripts has not been browsed by the user based on the first operation data, there being the script that needs to be displayed in the specified scripts, and take a script with most performance numbers in the specified scripts as the script that needs to be displayed; and
determine, in response to determining that a first target script in the specified scripts has been browsed by the user based on the first operation data, whether there is the script that needs to be displayed in the specified scripts based on second operation data of the user on the first target script and a priority order among the specified scripts.

15. The electronic device according to claim 14, wherein the computer-executable instructions configured the processor to determine whether there is the script that needs to be displayed in the specified scripts based on the second operation data of the user on the first target script and the priority order among the specified scripts, the processor comprise instructions to configure the processor to:
determine, in response to the second operation data representing that a script task of the first target script has been performed by the user and the script task of the first target script has not been completely performed, there being the script that needs to be displayed in the specified scripts, and take the first target script as the script that needs to be displayed; and
determine, based on the priority order among the specified scripts, whether there is the script that needs to be displayed in the specified scripts, in response to the second operation data representing that the script task of the first target script has not been performed by the user, or in response to the second operation data representing that the script task of the first target script has been performed by the user, and the script task of the first target script has been completely performed.

16. The electronic device according to claim 15, wherein the computer-executable instructions configured the processor to determine, based on the priority order among the specified scripts, whether there is the script that needs to be displayed in the specified scripts comprise instructions to configure the processor to:
determine, in response to determining there being a second target script with a priority ranking after the first target script in the specified scripts based on the priority order among the specified scripts, there being the script that needs to be displayed in the specified scripts, and take the second target script as the script that needs to be displayed; and
determine, in response to determining there being no second target script with the priority ranking after the first target script in the specified scripts based on the priority order among the specified scripts, there being no script that needs to be displayed in the specified scripts,
wherein the priority order among the specified scripts is determined based on authors of the specified scripts and performance numbers of the specified scripts.

17. The electronic device according to claim 12, wherein the computer-executable instructions configured the processor to display the first script entrance of the first script associated with the first e-book on the latest content page comprise instructions to configure the processor to:
acquire at least one of follows: author information of the first script, character information in the first script, content of the first script task, and third operation data of the user on the first script;
determine copywriting content of the first script entrance based on the acquired information; and
display the first script entrance on the latest content page based on the copywriting content of the first script entrance.

18. The electronic device according to claim 12, wherein the computer-executable instructions further configure the processor to, before displaying the first script page of the first script:
acquire progress information of the first script task being performed by the user; and
determine a script page of the first script matching the progress information as the first script page.

19. The electronic device according to claim 12, the computer-executable instructions further configure the processor to:
display a content discussion page of the first e-book in response to a second operation of the user on the first e-book, and display a second script entrance of a second script associated with the first e-book on the content discussion page; and
display a second script page of the second script in response to a trigger operation of the user on the second script entrance, the second script page being used to perform a second script task of the second script.

20. A non-transitory computer-readable storage medium, wherein the computer-readable storage medium is configured to store computer-executable instructions which, when being executed by a processor, configured the processor to:
display a latest content page of a first e-book in response to a first operation of a user on the first e-book;
display a first script entrance of a first script associated with the first e-book on the latest content page, or display a dialog entrance for a dialog with a digital assistant of the first e-book on the latest content page;
display, in a case that the first script entrance is displayed, in response to a trigger operation of the user on the first script entrance, a first script page of the first script, the first script page being used to perform a first script task of the first script; and
display, in a case that the dialog entrance is displayed, in response to a trigger operation of the user on the dialog entrance, a dialog page, the dialog page being used to the dialog with the digital assistant.
